(19) United States
(12) Patent Application Publication
(10) Pub. No.: US 2007/0129889 A1
(43) Pub. Date: Jun. 7, 2007

(54) Vehicle With A Navigation System

(76) Inventor: Philippe Alessandrini, Palo Alto, CA (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/566,290

(22) Filed: Dec. 4, 2006

Related U.S. Application Data
(60) Provisional application No. 60/741,930, filed on Dec. 2, 2005.

(51) Int. Cl. G01C 21/00

(52) U.S. Cl. 701/213; 701/200

(57) ABSTRACT

In a vehicle with a navigation system which includes a position-finding system to determine the position of the vehicle and a navigation control to integrate a marking to characterize the position of the vehicle in a satellite image from a vicinity of the position of the vehicle or to assign the marking to the satellite image, the position of marking, with reference to the satellite image, essentially corresponds to the position of the vehicle in the vicinity depicted by means of the satellite image, and the navigation system includes a display device to display the satellite image, together with the marking.

### CROSS-REFERENCE TO RELATED APPLICATIONS

This application claims the benefit of U.S. Provisional Application No. 60/741,930 filed on Dec. 2, 2005, entitled “KRAFTFAHRZEUG MIT EINEM NAVIGATIONSSYSTEM”.

### TECHNICAL FIELD

The invention concerns a vehicle with a navigation system, in which the navigation system includes a position-finding system to determine the position of the vehicle.

### BACKGROUND

EP 0 875 730 B1 and DE 698 15 940 T2 disclose a map information display device for use in a vehicle navigation device with a data conversion device to record points of map data corresponding to a map from a point of view through a viewing line that starts from the point of view and has a depth angle, with reference to the plane of the map, and is established perpendicular to the viewing line for perspective projection of the points of the map data onto a viewing plane, and has a stipulated distance from this point of view, in order to generate map display data. In this case, a bird's eye view of a vicinity is generated. A navigation system with a bird's eye view of a vicinity is also disclosed in FR 2634707 and in the journal autoconnect 2005, Vereinigte Motor-Verlage GmbH & Co. KG, Lauschnerstrasse 1,70174 Stuttgart, Germany, pages 18 and 21.

### SUMMARY

The object of the invention is to provide an improved vehicle with a navigation system.

The aforementioned object can be achieved by a vehicle with a navigation system, in which the navigation system includes
a position-finding system to determine the position of the vehicle,
a navigation control for integration of marking to characterize the position of the vehicle in a satellite image of a vicinity of the position of the vehicle or to assign the marking to the satellite image, in which the position and marking, with reference to the satellite image, corresponds essentially to the position of the vehicle in the vicinity depicted by means of the satellite image, and
a display device to display the satellite image together with the marking.

In one embodiment of the invention, the navigation system includes a route planner to determine a route, in which the route can be displayed in the satellite image.

In another embodiment of the invention, a street network of a map depiction can be displayed in the satellite image.

The aforementioned task is also solved by a method for operation of the vehicle with a navigation system (especially comprising one or more of the aforementioned features), in which the position of the vehicle is determined, and in which marking to characterize the position of the vehicle in a satellite image of a vicinity of the position of the vehicle is displayed, and in which the position of marking, with reference to the satellite image, corresponds essentially to the position of the vehicle in the vicinity depicted by means of the satellite image.

In another embodiment of the invention, a planned route is displayed in the satellite image.

In another embodiment of the invention, a street network of a map depiction is displayed in the satellite image.

Vehicle according to the invention is especially a land vehicle, usable individually in traffic. Vehicles according to the invention are not particularly restricted to land vehicles with an internal combustion engine.

### BRIEF DESCRIPTION OF THE DRAWINGS

Further advantages and details are apparent from the following description of practical examples.

FIG. 1 shows a practical example of a vehicle with a navigation system;

FIG. 2 shows a practical example of a method for operation of the vehicle with a navigation system according to FIG. 1;

FIG. 3 shows a practical example of a display by means of a display device; and

FIG. 4 shows another practical example of a display by means of a display device.

### DETAILED DESCRIPTION

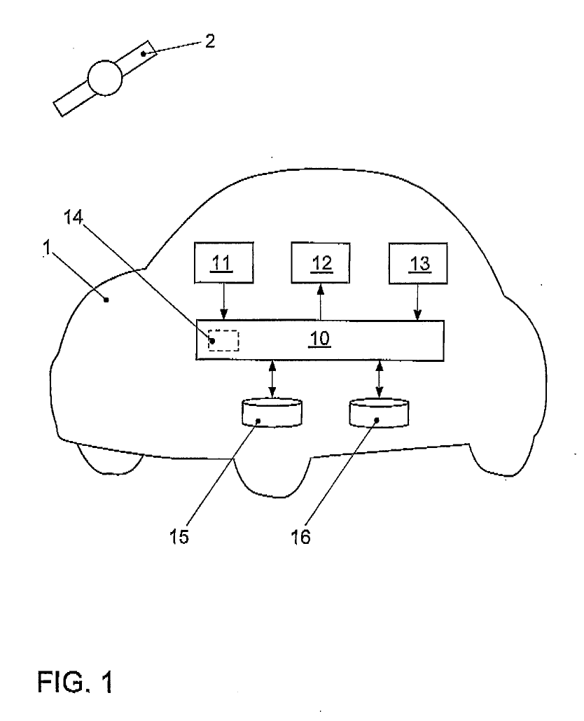

FIG. 1 shows a practical example of a vehicle 1 with a navigation system in a sketch. The navigation system includes a position-finding system 11 to determine the position of vehicle 1. The position-finding system 11 can be a position-finding system supported on a satellite 2, for example, a GPS position-finding system. The navigation system also includes a route atlas 15, in which map information is stored, as well as a database 16 with satellite images. It can be prescribed that the route atlas 15 and/or the database 16 can be updated with satellite images. Updating can occur, for example, via a WLAN connection (not shown).

The navigation system also includes a navigation control 10, among other things, for integration of marking to characterize the position of the vehicle 1 in a satellite image from a vicinity of the position of the vehicle 1, or to assign the marking to the satellite image. The position of marking is referenced to the satellite image, then essentially corresponds to the position of vehicle 1 in the vicinity depicted by the satellite image. The navigation system also includes an input device 13 and a display device 12, among other things, to display the satellite image together with the marking. The navigation control 10 includes a route planner 14, by means of which a route can be calculated from the position of the vehicle 1 to a destination that can be entered by means of the input device 13.

The input device 13 and the display device 12 can also serve to operate functions other than the navigation system. The input device 13 can be a touchscreen arranged over a display device 12, configured as a display. In addition, haptic feedback can be provided. The display device 12 is arranged in the passenger compartment of the vehicle 1. The display device 12 can be integrated in the steering wheel of vehicle 1 or the dashboard, optionally in a combined instrument of vehicle 1. The display device 12 can also be integrated in the rearview mirror of the vehicle 1.

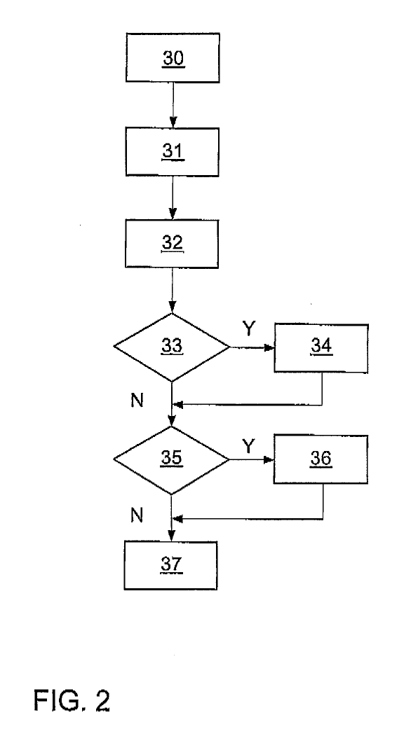

FIG. 2 shows a practical example of a method for operation of vehicle 1. The method begins with a step 30, in which the position of vehicle 1 is determined by means of the position-finding system 11. Step 31 follows step 30, in which a satellite image or a section of a satellite image of a vicinity of the position of vehicle 1 is selected from the database 16 with satellite images. Step 31 is followed by step 32, in which marking to characterize the position of vehicle 1 in the satellite image or its section is integrated, or in which the marking was assigned to the satellite image.

Step 32 is followed by a query 33 whether a planned route is present. If a planned route is present, query 33 is followed by step 34, in which the route is integrated in the satellite manipulated section, or in which the route is assigned to the satellite image. Step 34 is followed by a query 35. If no planned route is present, query 33 is followed directly by query 35, whether streets should be displayed. If streets are to be displayed, query 35 is followed by step 36, in which streets from the route atlas are integrated in the satellite image or its section, or in which the streets are assigned to the satellite image. Step 36 is followed by a step 37. If no streets are displayed, query 35 is directly followed by step 37.

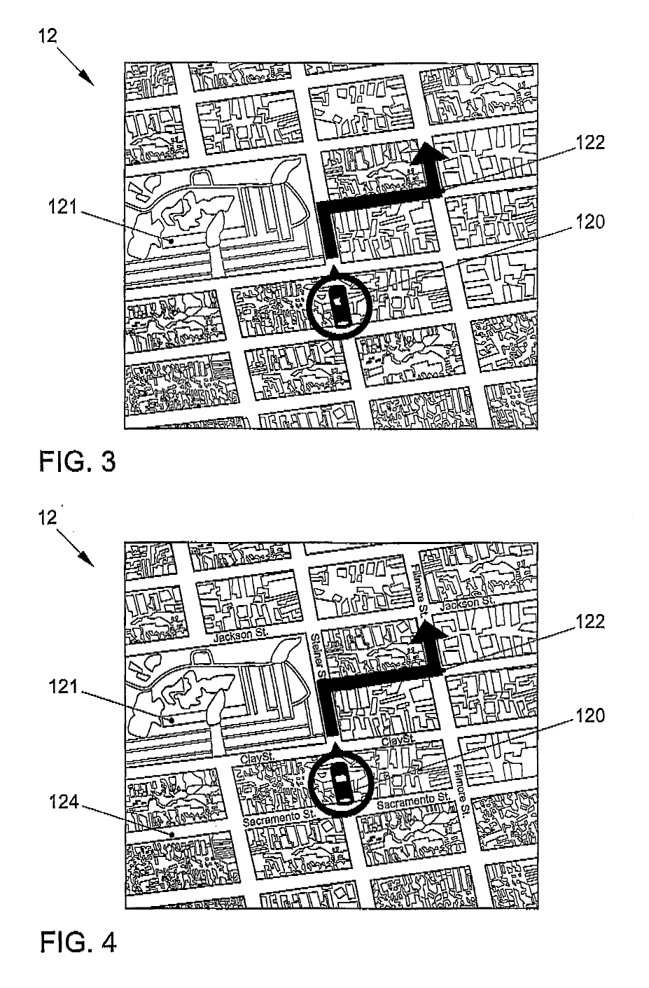

In step 37, for example, as shown in FIGS. 3 and 4, the marking 120 to characterize the position of vehicle 1, and optionally a route 122 or streets 124 are displayed, together with the satellite image, designated with reference number 121, on the display device 12.

FIG. 3 shows a practical example of a display device 12 in a situation, in which the marking 120 and the route 122 are displayed together with or in the satellite image 121. FIG. 4 shows a practical example of a display device 12 in a situation, in which the marking 120, route 122 and streets 124 are displayed together with or in the satellite image 121.

The display device 12 can be a simple or multilayer display. It can be prescribed that the display device 12 includes two displays arranged one above the other, in which one front display (designed transparent) is arranged in front of the other, rear display, with reference to the viewing position. In this case, it can be prescribed that the satellite image 121 is displayed by the rear display, and that the marking 120 and optionally the route 122 or streets 124 are displayed by means of the front display. It can also be prescribed that the display device 12 additionally includes a middle display arranged between the rear and front displays, in which the middle display is transparent. In this case, it can be prescribed that the satellite image 121 is displayed by the rear display, that the streets 124 are displayed by the middle display, and that the marking 121 and optionally the route 122 are displayed by means of the front display.

### LIST OF REFERENCE NUMBERS

1 Vehicle
2 Satellite
10 Navigation control
11 Position-finding system
12 Display device
13 Input device
14 Route planner
15 Route atlas
16 Database with satellite images
30, 31, 32, 34,
36, 37 Step
33, 35 Query
120 Marking
121 Satellite image
122 Route
124 Streets

1. A vehicle with a navigation system, the navigation system comprising:
a position-finding system to determine a position of the vehicle;
a navigation control for integrating a marking to characterize the position of the vehicle in a satellite image of the vicinity of the position of the vehicle, or to assign the marking to the satellite image, wherein the position of marking, with reference to the satellite image, essentially corresponds to the position of the vehicle in the vicinity depicted by means of the satellite image;
and a display device to display the satellite image, together with the marking.

2. A vehicle according to claim 1, the navigation system further comprising:
a route planner to determine a route, wherein the route is displayed in the satellite image.

3. A vehicle according to claim 1, wherein a street network of a map depiction is displayed in the satellite image.

4. A method for operation of a vehicle with a navigation system, the method comprising the steps of:
determining a position of the vehicle; and
displaying a marking to characterize the position of the vehicle in a satellite image from a vicinity of the position of the vehicle, wherein the position of marking, with reference to the satellite image, essentially corresponds to the position of the vehicle in the vicinity depicted by means of the satellite image.

5. A method according to claim 4, the method further comprising the step of:
displaying a planned route in the satellite image.

6. A method according to claim 4, the method further comprising the step of:
displaying of a street network of a map depiction in the satellite image.

7. A system for operation of a vehicle with a navigation system, comprising:
means for determining a position of the vehicle; and
means for displaying a marking to characterize the position of the vehicle in a satellite image from a vicinity of the position of the vehicle, wherein the position of marking, with reference to the satellite image, essentially corresponds to the position of the vehicle in the vicinity depicted by means of the satellite image.

8. A system according to claim 7, the further comprising:
means for displaying a planned route in the satellite image.

9. A system according to claim 7, further comprising:
means for displaying of a street network of a map depiction in the satellite image.
